(19) United States
(12) Patent Application Publication
(10) Pub. No.: US 2025/0179842 A1
(43) Pub. Date: Jun. 5, 2025

(54) LOCK DEVICE OF OPENED BACK DOOR FOR VEHICLE

(71) Applicant: AISIN CORPORATION, Kariya (JP)

(72) Inventors: Hideo MORIMOTO, Kariya-shi (JP); Masanobu Nishimoto, Kariya-shi (JP); Takayuki Sengoku, Kariya-shi (JP)

(73) Assignee: AISIN CORPORATION, Kariya (JP)

(21) Appl. No.: 18/931,632

(22) Filed: Oct. 30, 2024

(30) Foreign Application Priority Data
Dec. 5, 2023 (JP) 2023-205567

(51) Int. Cl. E05B 81/16; E05B 83/18

(52) U.S. Cl. CPC E05B 81/16; E05B 83/18

(57) ABSTRACT

A lock device of an opened back door for a vehicle includes a base member fixed to one of an opened back door of a vehicle and a vehicle body, a latch that is rotatable against the base member and engageable with a striker fixed to the other of the opened back door and the vehicle body, and a pole that is rotatable against the base member and engages with the latch to restrict the latch from rotating. The device locks the opened back door at a fully closed position by engaging with the striker in the latch. The device further includes an open lever that is rotatable against the base member, and a sub-lever that is rotatable against the open lever.

### CROSS REFERENCE TO RELATED APPLICATIONS

This application is based on and claims priority under 35 U.S.C. § 119 to Japanese Patent Application 2023-205567, filed on Dec. 5, 2023, the entire content of which is incorporated herein by reference.

### TECHNICAL FIELD

The present specification discloses a lock device of an opened back door for a vehicle.

### BACKGROUND DISCUSSION

In the related art, as a lock device for this type of opened back door for a vehicle, a lock device including a latch that engages with a striker as the latch rotates to lock a hood in a fully closed state, and a secondary lever including a hook portion that engages with the striker as the secondary lever rotates to lock the hood in a slightly opened state and a latch holding portion that restricts the latch engaged with the striker from rotating in a striker release direction has been proposed (for example, see JP 2010-65427A (Reference 1)). In the lock device, when the hood is closed, the striker engages with a striker engagement groove of the latch, and the latch holding portion of the secondary lever engages with a locking recessed portion of the latch to restrict the latch from returning to an opening position (fully locked state). When the secondary lever is slightly rotated away from the latch against the biasing force applied by operation from inside a vehicle, the latch holding portion escapes from the locking recessed portion and the latch is rotated in the release direction. As the latch is rotated, the striker is pushed by the latch to engage the hook portion of the secondary lever, and the hood is held slightly open (half locked state). When the secondary lever is rotated significantly against the biasing force applied by operation from inside the vehicle, the striker is released from the hook portion and the hood can be opened (open state). The number of parts can be reduced by using the secondary lever as a pole.

The above-described lock device of the opened back door for a vehicle is configured to be in the half locked state by slightly rotating the secondary lever by operation from inside the vehicle in the fully locked state, and configured to be in the open state by rotating the secondary lever a large amount by operation from inside the vehicle in the half locked state. Therefore, depending on the amount of operation from inside the vehicle, there is a risk that the opened back door may shift directly from the fully locked state to the open state with a single operation, resulting in unexpected opening of the opened back door.

A need thus exists for a lock device of an opened back door for a vehicle which is not susceptible to the drawback mentioned above.

### SUMMARY

According to an aspect of this disclosure, a lock device of an opened back door for a vehicle includes a base member fixed to one of an opened back door of a vehicle and a vehicle body, a latch that is rotatable against the base member and engageable with a striker fixed to the other of the opened back door and the vehicle body, and a pole that is rotatable against the base member and engages with the latch to restrict the latch from rotating, in which the device locks the opened back door at a fully closed position by engaging with the striker in the latch, the device further includes an open lever that is rotatable against the base member, and a sub-lever that is rotatable against the open lever, the latch is formed with a half locked engagement portion that engages with the pole in a half locked state and a fully locked engagement portion that engages with the pole in a fully locked state, the half locked engagement portion and the fully locked engagement portion being aligned circumferentially, the pole rotates around an axis of a rotation shaft in one direction as the pole engages with the half locked engagement portion and the fully locked engagement portion in sequence from an open state of the latch, and disengages from the fully locked engagement portion and the half locked engagement portion in sequence as the pole rotates around the axis of the rotation shaft in the other direction opposite to the one direction from the fully locked state, the pole is formed with a first pressed portion with which the open lever is engageable at a first rotation angle which is a rotation angle of the pole when the pole engages with the fully locked engagement portion, and a second pressed portion with which the sub-lever is engageable at a second rotation angle which is a rotation angle of the pole when the pole disengages from the fully locked engagement portion and engages with the half locked engagement portion, and when the open lever rotates in a state where the pole is located at the first rotation angle and engages with the fully locked engagement portion, the open lever engages with the first pressed portion, rotates the pole in the other direction from the first rotation angle to the second rotation angle, and disengages the pole from the fully locked engagement portion, and after the open lever is returned from the rotation thereof, when the open lever rotates in a state where the pole is located at the second rotation angle and engages with the half locked engagement portion, the sub-lever engages with the second pressed portion, rotates the pole in the other direction from the second rotation angle, and disengages the pole from the half locked engagement portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle provided with a hood lock device as a lock device of an opened back door for a vehicle in the present disclosure;

FIG. 2 is an external perspective view of a front side of the hood lock device;

FIG. 3 is an external perspective view of the front side of the hood lock device, excluding a cover member;

FIG. 4 is an external perspective view of a rear surface side of the hood lock device;

FIG. 5 is an exploded perspective view of the hood lock device;

FIG. 6 is a schematic configuration view of a latch;

FIG. 7 is a schematic configuration view of a pole;

FIGS. 8A, 8B, and 8C are explanatory views showing an open state, a half locked state, and a fully locked state of the latch;

FIG. 9 is a schematic configuration view of the pole, an open lever, and a sub-lever;

FIG. 10 is a schematic configuration view of the sub-lever;

FIG. 11 is a schematic configuration view of a close lever and a hook member;

FIG. 12 is an explanatory view showing how the latch is operated by the close lever to a fully locked position;

FIG. 13 is an explanatory view showing how the latch is operated by the close lever to the fully locked position;

FIG. 14 is an explanatory view showing the hood lock device when an operation of releasing full lock is started.

FIG. 15 is an explanatory view showing the hood lock device when the open lever contacts the pole after the operation of releasing the full lock is started;

FIG. 16 is an explanatory view showing the hood lock device when the full lock is released;

FIG. 17 is an explanatory view showing the hood lock device in the half locked state;

FIG. 18 is an explanatory view showing the hood lock device when the pole engages with a half engagement surface and the open lever returns to an initial position;

FIG. 19 is an explanatory view showing the hood lock device when an operation of releasing half lock is started;

FIG. 20 is an explanatory view showing the hood lock device when the sub-lever contacts the pole after the operation of releasing the half lock is started;

FIG. 21 is an explanatory view showing the hood lock device when the half lock is released;

FIG. 22 is an explanatory view showing the hood lock device when the operation of releasing the half lock is ended;

FIG. 23 is an explanatory view showing the hood lock device when the latch contacts the sub-lever when the latch is fully locked from the open state;

FIG. 24 is an explanatory view showing the hood lock device just before the latch is fully locked; and

FIG. 25 is an explanatory view showing the hood lock device in the fully locked state.

### DETAILED DESCRIPTION

The embodiment in which this disclosure is to be implemented will be described with reference to drawings.

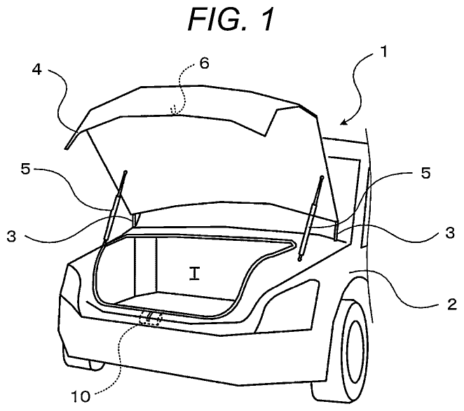

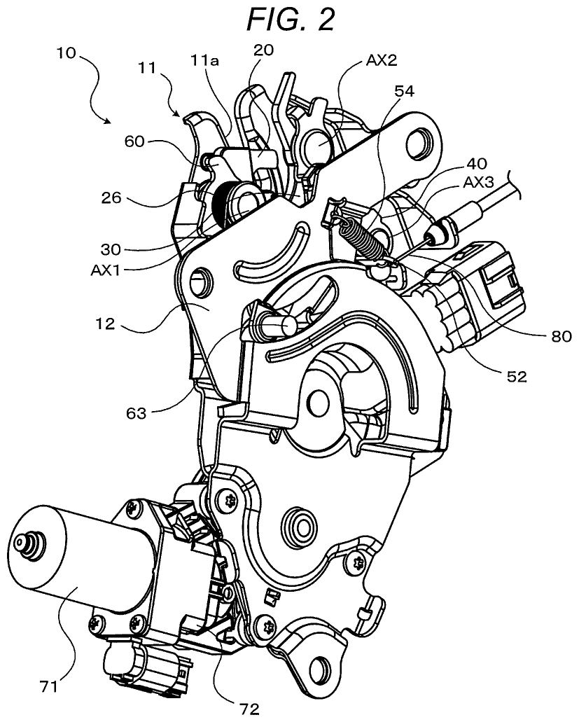

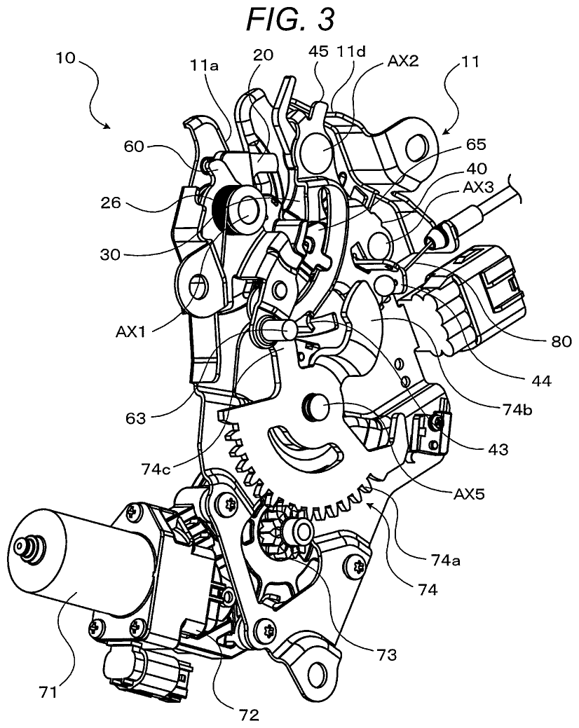

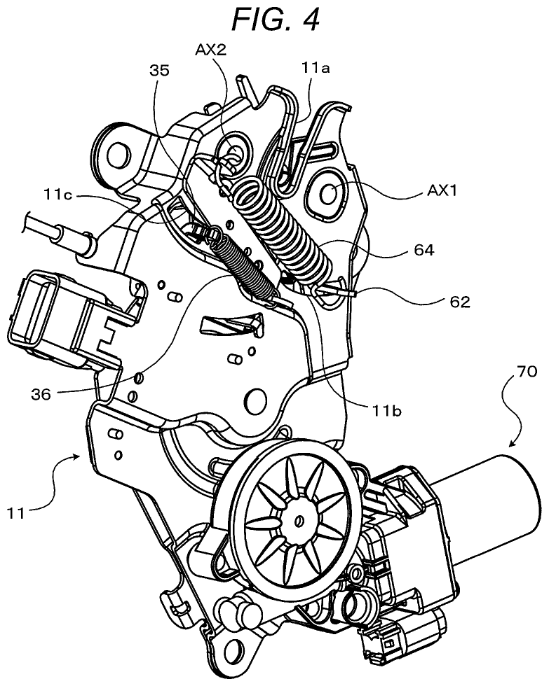

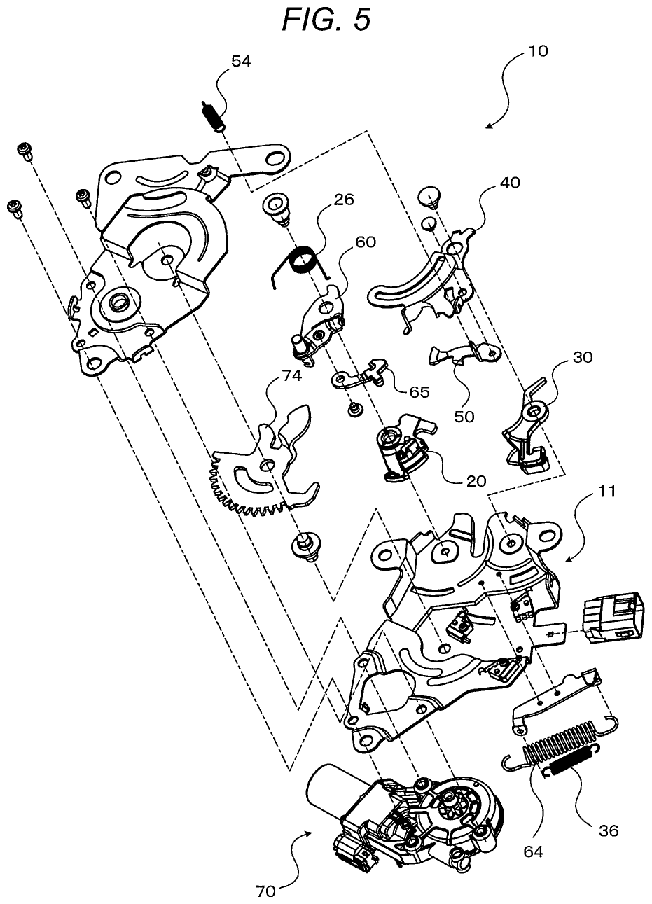

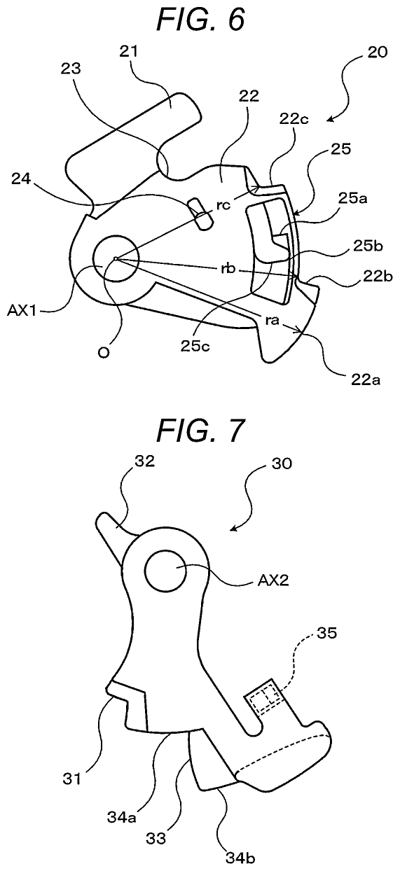

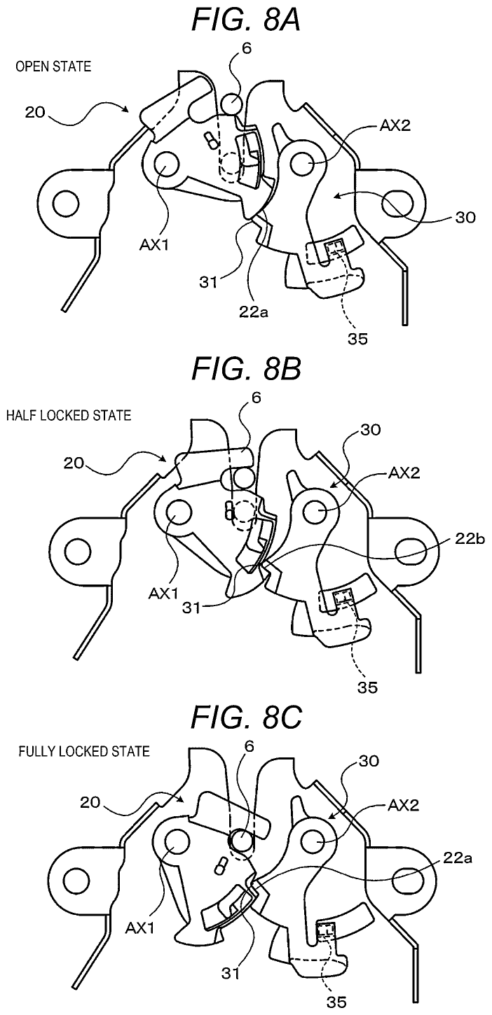

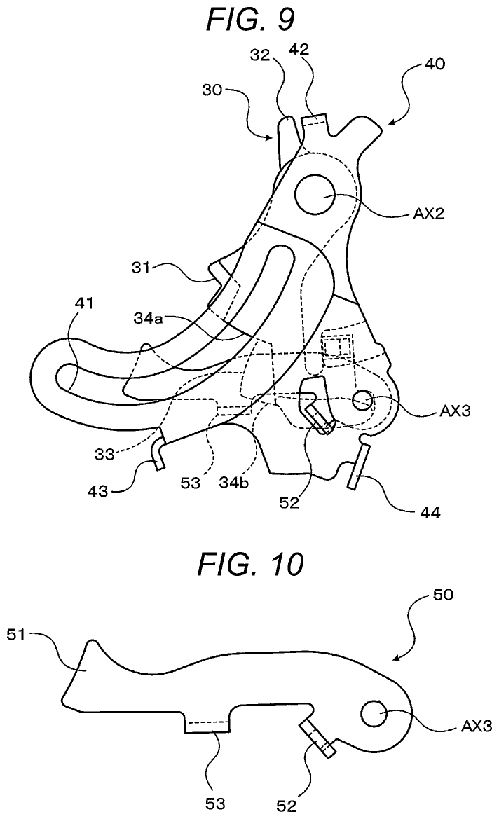

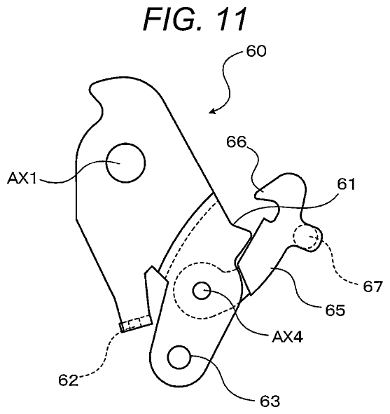

FIG. 1 is a perspective view of a vehicle 1 provided with a hood lock device 10 as a lock device of an opened back door for a vehicle in the present disclosure, FIGS. 2 and 3 are external perspective views of the front side of the hood lock device 10, FIG. 4 is an external perspective view of the rear surface side of the hood lock device 10, and FIG. 5 is an exploded perspective view of the hood lock device 10. In addition, FIG. 6 is a schematic configuration view of a latch 20, FIG. 7 is a schematic configuration view of a pole 30, and FIGS. 8A, 8B, and 8C are explanatory views showing an open state, a half locked state, and a fully locked state of the latch 20. Further, FIG. 9 is a schematic configuration view of the pole 30, an open lever 40, and a sub-lever 50, FIG. 10 is a schematic configuration view of the sub-lever 50, and FIG. 11 is a schematic configuration view of a close lever 60 and a hook member 65.

As shown in FIG. 1, the vehicle 1 includes a front trunk T as an accommodation space installed in the front portion of a vehicle body 2, a hood 4 freely supported by the vehicle body 2 to rotate up and down via a hinge 3 to cover the front trunk T, a telescopic support member 5 that is interposed between the vehicle body 2 and the hood 4, a hood opening and closing device (not shown) that opens and closes the hood 4 by expanding and retracting the support member 5 electrically, and the hood lock device 10 of the present embodiment that locks the hood 4 at a fully closed position. The hood lock device 10 is installed in the opening portion of the front trunk T to engage with a striker 6 fixed to the inner surface of the front end portion of the hood 4.

As shown in FIGS. 2 to 5, the hood lock device 10 has a base member 11 that is fixed to the vehicle body 2 and formed with a striker groove 11a for receiving the striker 6, a cover member 12 that is fixed to the base member 11 to cover the interior of the hood lock device 10 together with the base member 11, the latch 20 that is rotatable with respect to the base member 11 and is engageable with the striker 6 fixed to the hood 4, the pole 30 that is rotatable with respect to the base member 11 and engages with the latch 20 to restrict the rotation of the latch 20, the close lever 60 that is rotatable integrally with the latch 20 by engaging with the latch 20, the hook member 65 that is rotatably connected to the close lever 60, a closer drive unit 70, the open lever 40 that is rotatable integrally with respect to the pole 30 by engaging with the pole 30, and the sub-lever 50 that is rotatably connected to the open lever 40.

The latch 20 is rotatable around the axis of a rotation shaft AX1 fixed to the base member 11. As shown in FIG. 6, the latch 20 has a locking portion 24 at a position separated in the radial direction from the rotation shaft AX1, and one end of a latch spring 26 (torsion spring), the other end of which is locked to the base member 11, is locked to the locking portion 24. As a result, the latch 20 is biased around the axis of the rotation shaft AX1 in the counterclockwise direction (the opening side for releasing the striker 6) in FIG. 6.

In addition, as shown in FIG. 6, the latch 20 has first and second claw portions 21 and 22 that define a notch portion 23 that engages with the striker 6. The second claw portion 22 is formed with an open-engagement surface 22a that engages with the pole 30 in an open state (a state in which the striker 6 is opened), a half engagement surface 22b that engages with the pole 30 in a half locked state (a state in which the hood 4 is slightly opened), and a full engagement surface 22c that engages with the pole 30 in a fully locked state (a state in which the hood 4 is fully closed). The open-engagement surface 22a, the half engagement surface 22b, and the full engagement surface 22c are formed on the outer circumferential portion of the second claw portion 22 in this order to be arranged in the clockwise direction in FIG. 6. The open-engagement surface 22a is an arc-shaped surface centered on the rotation shaft AX1. The half engagement surface 22b and the full engagement surface 22c are planar surfaces radially extending in the radial direction of the latch 20. The rotation angle of the latch 20 when the pole 30 engages with the half engagement surface 22b is referred to as a half locked position, and the rotation angle of the latch 20 when the pole 30 engages with the full engagement surface 22c is referred to as a fully locked position. A distance ra from a center O of the rotation shaft AX1 of the latch 20 to the open-engagement surface 22a is longer than a distance rb from the center O of the rotation shaft AX1 to the end portion of the half engagement surface 22b on the rotation shaft AX1 side, and the distance rb is longer than a distance rc from the center O of the rotation shaft AX1 to the end portion of the full engagement surface 22c on the rotation shaft AX1 side.

In addition, as shown in FIG. 6, an engagement block portion 25 is formed on the side surface of the second claw portion 22 (surface on the shaft direction side of the rotation shaft AX1), which protrudes in the shaft direction of the rotation shaft AX1 and extends in an arc shape centered on the rotation shaft AX1 from near the full engagement surface 22c to the middle of the open-engagement surface 22a. The engagement block portion 25 is formed with a hook engagement surface 25a with which the hook member 65 rotatably connected to the close lever 60 is engageable, a hook contact surface 25b that is provided in the circumferential direction in succession with the hook engagement surface 25a and with which the hook member 65 can come into contact, a sub-lever contact surface 25c with which the sub-lever 50 can come into contact, and a pop-up engagement surface 25d with which the close lever 60 is engageable. The hook engagement surface 25a is formed by a planar surface extending in the radial direction from the rotation shaft AX1 so that the hook member 65 is engageable with the hook engagement surface 25a when the latch 20 is located in the opening side (pull-in start position) from the half locked position. The latch 20 is rotatable around the axis of the rotation shaft AX1 in the clockwise direction (closed side) in FIG. 7 by power from the closer drive unit 70, integrally with the close lever 60, when the hook member 65 is engaged with the hook engagement surface 25a. The hook contact surface 25b is formed by a surface extending in an arc shape centered on the rotation shaft AX1 from the end portion of the hook engagement surface 25a in the radial direction. The sub-lever contact surface 25c is formed by a planar surface extending in the radial direction of the rotation shaft AX1 on the open-engagement surface 22a side of the second claw portion 22. The pop-up engagement surface 25d is formed by a planar surface extending in the radial direction of the rotation shaft AX1 on the open-engagement surface 22a side of the second claw portion 22.

The pole 30 is a plate-shaped member and is rotatable around the axis of a rotation shaft AX2 fixed to the base member 11 parallel to the rotation shaft AX1. As shown in FIGS. 4 and 7, the pole 30 has a locking portion 35 that is inserted into a long guide hole 11c formed in the base member 11 to form an arc shape centered on the rotation shaft AX2, and one end of a pole spring 36 (coil spring), the other end of which is locked to the base member 11, is locked to the locking portion 35. As a result, the pole 30 is biased around the axis of the rotation shaft AX2 in the clockwise direction (one direction) in FIG. 7.

In addition, the pole 30 has an engagement portion 31 extending in the radial direction of the rotation shaft AX2 to engage with the open-engagement surface 22a, the half engagement surface 22b, and the full engagement surface 22c of the latch 20, as shown in FIGS. 8A, 8B, and 8C. The pole 30 rotates around the axis of the rotation shaft AX2 in the clockwise direction (in one direction) in FIGS. 8A, 8B, and 8C as the engagement portion 31 engages with the open-engagement surface 22a, the half engagement surface 22b, and the full engagement surface 22c in sequence. In addition, the pole 30 disengages the engagement portion 31 from the full engagement surface 22c and the half engagement surface 22b in sequence as the pole 30 rotates around the axis of the rotation shaft AX2 in the counterclockwise direction (in the other direction) in FIGS. 8A, 8B, and 8C. The rotation angle of the pole 30 when the pole 30 engages with the latch 20 on the full engagement surface 22c is referred to as full engagement rotation angle (first rotation angle), and the rotation angle of the pole 30 when the pole 30 engages with the latch 20 on the half engagement surface 22b is referred to as half engagement rotation angle (second rotation angle). In addition, the rotation angle of the pole 30 when the pole 30 engages with the latch 20 on the open-engagement surface 22a is referred to as open-engagement rotation angle.

Further, the pole 30 has a full release pressed portion 32 (first pressed portion) with which the open lever 40 is engageable in the circumferential direction of the rotation shaft AX2, a half release pressed portion 33 (second pressed portion) with which the sub-lever 50 is engageable in the circumferential direction of the rotation shaft AX2, a first sub-lever support portion 34a that can support the sub-lever 50 at a position in the radial direction of the rotation shaft AX2 at which the sub-lever 50 is engageable with the half release pressed portion 33, and a second sub-lever support portion 34b that can support the sub-lever 50 at a position in the radial direction of the rotation shaft AX2 at which the sub-lever 50 is not engageable with the half release pressed portion 33. The full release pressed portion 32 is a protrusion portion that protrudes in the radial direction from the rotation shaft AX2 to be pressed in the circumferential direction of the rotation shaft AX2 by the open lever 40 at a different position from the engagement portion 31. The half release pressed portion 33 is a surface extending in the radial direction from the rotation shaft AX2 to be pressed in the circumferential direction of the rotation shaft AX2 by the sub-lever 50 at a different position from the engagement portion 31 and the full release pressed portion 32. The first sub-lever support portion 34a is a surface extending from the end portion of the rotation shaft AX2 side of the half release pressed portion 33 in the radial direction to the circumferential direction of the rotation shaft AX2 (in the counterclockwise direction in FIG. 7). The second sub-lever support portion 34b is a surface extending from the outer circumferential end portion in the radial direction of the half release pressed portion 33 in the circumferential direction of the rotation shaft AX2 (in the clockwise direction in FIG. 7).

The open lever 40 is a plate-shaped member that is superimposed on the pole 30 in the shaft direction of the rotation shaft AX2 and is rotatable coaxially with the pole 30 around the axis of the rotation shaft AX2, as shown in FIG. 9. The open lever 40 has an engagement portion 42 that is engageable with the full release pressed portion 32 (first pressed portion) of the pole 30, and first and second operated portions 43 and 44 for actuating (rotating) the open lever 40. The engagement portion 42 is engageable with the full release pressed portion 32 in the clockwise direction (in one direction) in FIG. 9 when the pole 30 is located at the full engagement rotation angle (first rotation angle), and extends in the radial direction from the rotation shaft AX2 so that the engagement portion 42 is not engageable with the full release pressed portion 32 when the pole 30 is located at the half engagement rotation angle (second rotation angle). In the present embodiment, the engagement portion 42 is configured as a bent portion bent to the pole 30 side at the extension end from the rotation shaft AX2 in the radial direction. As a result, the engagement portion 42 can be formed by simpler processing. The first operated portion 43 is formed on the outer circumferential portion of the open lever 40 to engage with a sector gear 74 that rotates by the actuation of the closer drive unit 70. The open lever 40 rotates in the counterclockwise direction (in the other direction) in FIG. 9 as the sector gear 74 rotates with the sector gear 74 engaged with the first operated portion 43. The second operated portion 44 is formed at a different position from the first operated portion 43 on the outer circumferential portion of the open lever 40. One end of a cable 80 (see FIG. 3) is locked to the second operated portion 44, and the other end of the cable 80 is locked to an unlock lever (not shown) located in the vehicle interior. The open lever 40 rotates in the counterclockwise direction (in the other direction) in FIG. 9 when the cable 80 is pulled by the operator's operation of the unlock lever. In the fully locked state where the pole 30 is located at the full engagement rotation angle, the engagement portion 42 of the open lever 40 engages with the full release pressed portion 32 of the pole 30 when the open lever 40 rotates in the counterclockwise direction (in the other direction) in FIG. 9. The pole 30 rotates in the counterclockwise direction (in the other direction) in FIG. 9, integrally with the open lever 40 when the full release pressed portion 32 is pressed by the open lever 40, and the engagement portion 31 is detached from the full engagement surface 22c of the latch 20. As a result, the fully locked state can be released by actuating the closer drive unit 70 or operating the unlock lever. Here, the amount of stroke (rotation amount) of the open lever 40 that is rotated by one-time actuation of the closer drive unit 70 or one-time operation of the unlock lever is adjusted to be the amount obtained by adding a small margin to the amount required to release the fully locked state, that is, the amount required for the pole 30 to rotate in the counterclockwise direction (in the other direction) in FIG. 9 from the state where the engagement portion 31 of the pole 30 is engaged with the full engagement surface 22c (full engagement rotation angle) to the state where the engagement portion 31 is detached from the full engagement surface 22c (half engagement rotation angle). In the present embodiment, the half locked state can also be released by stroking (rotating) the open lever 40 approximately the same amount from the initial position after the fully locked state is released, details of which are described below. In addition, the open lever 40 is positioned at the initial position with respect to the latch 20 by the biasing force from a sub-lever spring 54 described below. The initial position depends strictly on the rotational position of the latch 20.

In addition, the open lever 40 is also formed with a protrusion 45 that protrudes in the radial direction from the rotation shaft AX2 at a different position from the engagement portion 42, as shown in FIG. 9. The protrusion 45 protrudes through a notch portion 11d formed in the base member 11, as shown in FIG. 3. The protrusion 45 restricts the open lever 40 from rotating around the axis of the rotation shaft AX2 in the clockwise direction in FIG. 3 at the restricted position beyond the initial position by abutting against the edge of the notch portion 11d on the circumferential direction side.

Further, the open lever 40 is also formed with an arc-shaped guide hole 41. The guide hole 41 is formed so that the open lever 40 is formed in an arc shape centered on the rotation shaft AX1 (rotation shaft of the close lever 60) at the initial position.

The sub-lever 50 is a plate-shaped member interposed between the pole 30 and the open lever 40, and is rotatably connected to the open lever 40 at the base end portion thereof via a rotation shaft AX3 parallel to the rotation shaft AX2, as shown in FIG. 9. The distal end portion of the sub-lever 50 is designated as a free end portion 51. As shown in FIG. 10, the sub-lever 50 has an engagement portion 53 formed on the side portion between the base end portion thereof and the free end portion 51, and a locking portion 52 formed on the side portion of the base end side of the sub-lever from the engagement portion 53. One end of the sub-lever spring 54, the other end of which is locked to the locking portion 52, is locked to the cover member 12, as shown in FIG. 2. The sub-lever spring 54 is a coil spring in the present embodiment, which biases the open lever 40 via the sub-lever 50 around the axis of the rotation shaft AX2 in the clockwise direction (in one direction) in FIG. 9. In the present embodiment, the engagement portion 53 is configured as a bent portion bent to the pole 30 side. As a result, the engagement portion 53 can be formed by simpler processing. The engagement portion 53 is located near the second sub-lever support portion 34b of the pole 30 in a state where the pole 30 is located at the full engagement rotation angle (first rotation angle) and is not engageable with the half release pressed portion 33 (second pressed portion). In addition, the engagement portion 53 is located near the first sub-lever support portion 34a of the pole 30 in a state where the pole 30 is located at the half engagement rotation angle (second rotation angle) and is engageable with the half release pressed portion 33. In a state where the engagement portion 53 of the sub-lever 50 is located near the first sub-lever support portion 34a, that is, in the half locked state where the pole 30 is located at the half engagement rotation angle, the engagement portion 53 of the sub-lever 50 engages with the half release pressed portion 33 of the pole 30 when the open lever 40 rotates in the counterclockwise direction (in the other direction) in FIG. 9. The pole 30 further rotates in the counterclockwise direction (in the other direction) in FIG. 9 from the half engagement rotation angle to the open-engagement rotation angle, integrally with the open lever 40 when the half release pressed portion 33 is pressed by the sub-lever 50 as the open lever 40 rotates. As a result, as with the release of the fully locked state, the half locked state can be released by actuating (rotating) the open lever 40 by actuating the closer drive unit 70 or operating the unlock lever. Here, the rotation amount of the pole 30 from the full engagement rotation angle to the half engagement rotation angle and the rotation amount of the pole 30 from the half engagement rotation angle to the open-engagement rotation angle are substantially the same, and the fully locked and half locked states can be released by stroking (rotating) the open lever 40 the same amount from the initial position, respectively. As a result, the fully locked and half locked states can be released separately by a simple mechanism.

The close lever 60 is rotatable coaxially with the latch 20 around the axis of the rotation shaft AX1, and as shown in FIG. 11, has an engagement portion 61 that is engageable with the latch 20, a locking portion 62 to which a pop-up spring 64 that biases the close lever 60 is locked, and an operated portion 63 for actuating (rotating) the close lever 60. The engagement portion 61 extends in the radial direction of the rotation shaft AX1 to engage with the pop-up engagement surface 25d formed on the engagement block portion 25 of the latch 20. One end of the pop-up spring 64, the other end of which is locked to the locking portion 62, is locked to the base member 11, as shown in FIG. 4. The pop-up spring 64 is a coil spring in the present embodiment, which biases the close lever 60 around the axis of the rotation shaft AX1 in the counterclockwise direction (opening side) in FIG. 11. The latch 20 engages with the engagement portion 61 of the close lever 60 on the pop-up engagement surface 25d and is biased around the axis of the rotation shaft AX1 to the opening side, integrally with the close lever 60 by the biasing force of the pop-up spring 64. As a result, when the half locked state is released, the latch 20 (second claw portion 22) can push the striker 6 out and pop up the hood 4 in a slightly opened state. The locking portion 62 is inserted into a guide hole 11b formed in the base member 11 in an arc shape centered on the rotation shaft AX1. The guide hole 11b defines the extent of the biasing force of the pop-up spring 64 acting on the close lever 60 (latch 20). In the present embodiment, the guide hole 11b is formed to bias the latch 20 to the opening side from the end of the stroke on the closed side from the fully locked position to the position on the opening side from the half locked position.

The operated portion 63 is formed in a cylindrical shape to protrude in a direction parallel to the rotation shaft AX2 of the close lever 60 from a position separated from the rotation shaft AX2 such that the sector gear 74 can be engaged. The close lever 60 rotates around the axis of the rotation shaft AX1 in the clockwise direction (closed side) in FIG. 11 when the operated portion 63 is pressed as the sector gear 74 rotates.

As shown in FIG. 3, the closer drive unit 70 has a closer motor 71, an output gear 73 that meshes with the sector gear 74, and a reduction gear mechanism 72 that reduces the power from the closer motor 71 and transmits the power to the output gear 73. The sector gear 74 is rotatable around the axis of an rotation shaft AX5 parallel to the rotation shafts AX1 and AX2, and has a fan-shaped gear portion 74a that meshes with the output gear 73, a close engagement portion 74b that extends in the radial direction of the rotation shaft AX5 at a different position from the gear portion 74a, and an open engagement portion 74c that extends in the radial direction of the rotation shaft AX5 at a different position from the gear portion 74a and the close engagement portion 74b. The sector gear 74 rotates in the counterclockwise direction in FIG. 3 by the power transmitted from the closer drive unit 70, causing the close engagement portion 74b to engage with the operated portion 63 of the close lever 60 and rotate the close lever 60 around the axis of the rotation shaft AX1 in the clockwise direction (closed side) in FIG. 3. In addition, the sector gear 74 rotates in the clockwise direction in FIG. 3 by the power in the reverse rotational direction transmitted from the closer drive unit 70 to cause the open engagement portion 74c engage with the first operated portion 43 of the open lever 40 and rotate the open lever 40 around the axis of the rotation shaft AX2 in the counterclockwise direction (in the other direction) in FIG. 3.

The hook member 65 is rotatably connected to the close lever 60 at the base end portion thereof via a rotation shaft AX4 parallel to the rotation shaft AX1, as shown in FIG. 11. The distal end portion of the hook member 65 is formed with an engagement claw 66 extending toward the second claw portion 22 (engagement block portion 25) of the latch 20 and a cylindrical insertion portion 67 protruding in a direction parallel to the shaft direction of the rotation shaft AX4. The insertion portion 67 is inserted into the guide hole 41 of the open lever 40. As described above, the open lever 40 is biased around the axis of the rotation shaft AX2 in the clockwise direction in FIG. 12 via the sub-lever 50 by the sub-lever spring 54, and the hook member 65 is biased to the engagement block portion 25 (hook engagement surface 25a and hook contact surface 25b) of the latch 20 by the biasing force acting on the open lever 40. The open lever 40 is positioned at the initial position with respect to the latch 20 when the engagement claw 66 of the hook member 65 is pressed against the hook engagement surface 25a and hook contact surface 25b of the engagement block portion 25.

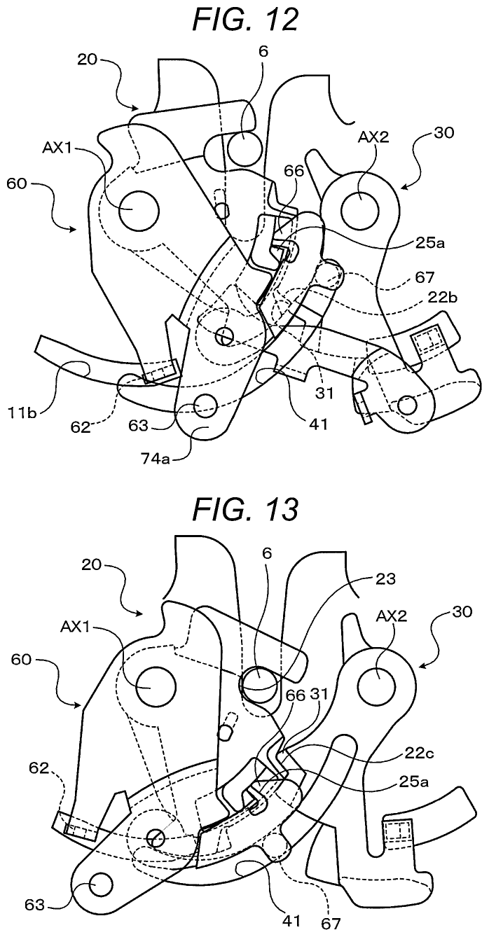

The engagement claw 66 of the hook member 65 is pressed against the hook contact surface 25b formed on the engagement block portion 25 of the latch 20 by the biasing force acting on the open lever 40 described above in the open state where the latch 20 is released from the striker 6. The engagement claw 66 of the hook member 65 slides against the hook contact surface 25b when the latch 20 rotates from the open state to the closed side, and engages with the hook engagement surface 25a in a state where the latch 20 is located at a rotation angle on the opening side (pull-in start position) from the half locked position, as shown in FIG. 12. When the close engagement portion 74b of the sector gear 74 engages with the operated portion 63 and presses the operated portion 63 by actuation of the closer drive unit 70, the close lever 60 rotates around the axis of the rotation shaft AX1 in the clockwise direction (closed side) in FIG. 12, and the hook member 65 (engagement claw 66) connected to the close lever 60 moves along the guide hole 41 of the open lever 40 in an arc-shaped trajectory centered on the rotation shaft AX1. As a result, the latch 20 rotates around the axis of the rotation shaft AX1 in the clockwise direction (closed side) in FIG. 12, integrally with the close lever 60 and pulls in the striker 6 with the first claw portion 21. The pole 30 engages with the half engagement surface 22b and the full engagement surface 22c in sequence at the engagement portion 31 as the latch 20 rotates. As shown in FIG. 13, when the pole 30 engages with the full engagement surface 22c at the engagement portion 31, the latch 20 is locked in a state where the latch 20 engages with the striker 6 at the notch portion 23 (fully locked position) against rotation.

When the closer drive unit 70 stops due to some abnormality while the latch 20 is being rotated to the closed side, the latch 20 is locked together with the close lever 60 (hook member 65). Therefore, the unlock lever is used to operate the open lever 40 to detach the hook member 65 from the hook engagement surface 25a of the latch 20 to unlock the latch 20. In this case, since the latch 20 rotates to the opening side by the biasing force of the latch spring 26 and is in the open state, the hook member 65 is separated from the hook engagement surface 25a and hook contact surface 25b of the latch 20. As a result, the open lever 40 is no longer positioned at the initial position. When the open lever 40 rotates beyond the initial position by the biasing force of the sub-lever spring 54, the hook member 65, which is connected to the open lever 40 via the insertion portion 67, enters the rotation shaft AX1 side of the latch 20 (see FIG. 3). In this state, even if the latch 20 is rotated from the open state to the closed side, the latch 20 interferes with the hook member 65 and cannot be rotated to the closed side. In the present embodiment, such inconvenience does not occur because the open lever 40 is restricted from rotating beyond the restricted position by the protrusion 45 abutting against the notch portion 11d of the base member 11 at the restricted position described above.

In the vehicle 1 of the present embodiment, the hood 4 can be opened and closed manually by the operator or electrically by the hood opening and closing device. When the hood 4 is fully closed electrically, the control device of the vehicle 1 controls the hood opening and closing device such that the hood 4 rotates in the closing direction when the hood 4 is instructed to be fully closed by the operator's operation of a remote control or the like. As the hood 4 rotates in the closing direction, the striker 6 formed on the hood 4 enters the striker groove 11a of the base member 11 and contacts and presses the second claw portion 22 of the latch 20 in the open state, causing the latch 20 to rotate to the closed side. The control device of the vehicle 1 controls the hood opening and closing device such that the hood 4 rotates in the closing direction until the latch 20 reaches the pull-in start position. When the latch 20 reaches the pull-in start position, the hook member 65 connected to the close lever 60 engages with the latch 20. The control device of the vehicle 1 controls the closer motor 71 such that the close lever 60 rotates to the closed side. The latch 20 rotates to the closed side, integrally with the close lever 60, pulls in the striker 6, and is locked by being engaged with the pole 30 at the fully locked position. As a result, the hood 4 is locked at the fully closed position.

Next, the operation when the fully locked state is released or the half locked state is released by the operator's operation of the unlock lever will be described. The hood lock device 10 of the present embodiment is configured to enter the half locked state that when the unlock lever is operated once in the fully locked state, and to enter the open state when the unlock lever is operated one more time in the half locked state. In other words, the hood lock device 10 of the present embodiment requires two times of operation of the unlock lever to transit from the fully locked state to the open state. By preventing a direct transition from the fully locked state to the open state, the hood 4 can be prevented from being opened unexpectedly.

First, the operation of the hood lock device 10 when the fully locked state is released will be described with reference to FIGS. 14 to 18. As shown in FIG. 14, in the fully locked state, the engagement portion 53 of the sub-lever 50 is located near the second sub-lever support portion 34b of the pole 30 and is not engageable with the half release pressed portion 33 (second pressed portion).

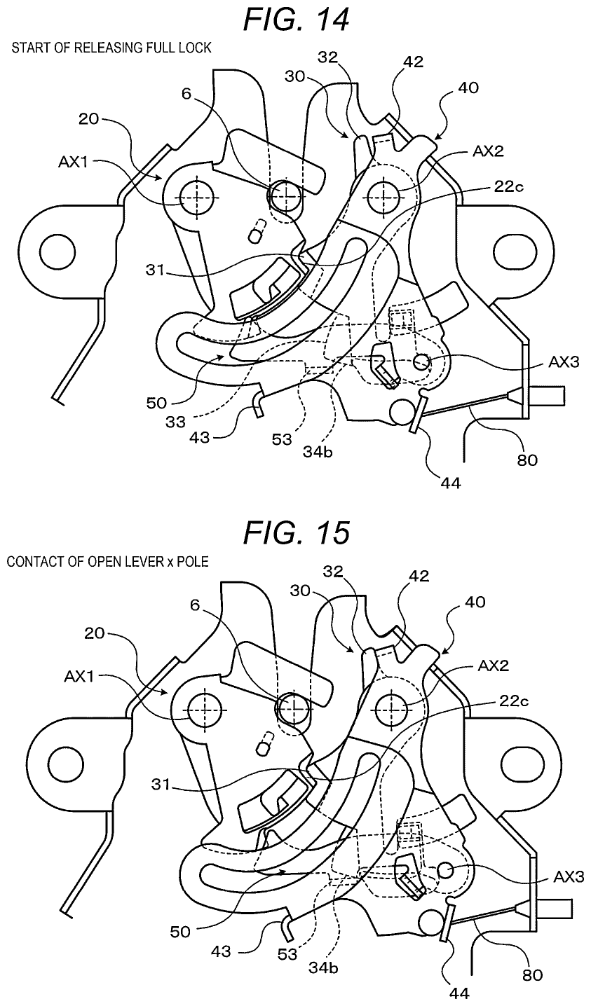

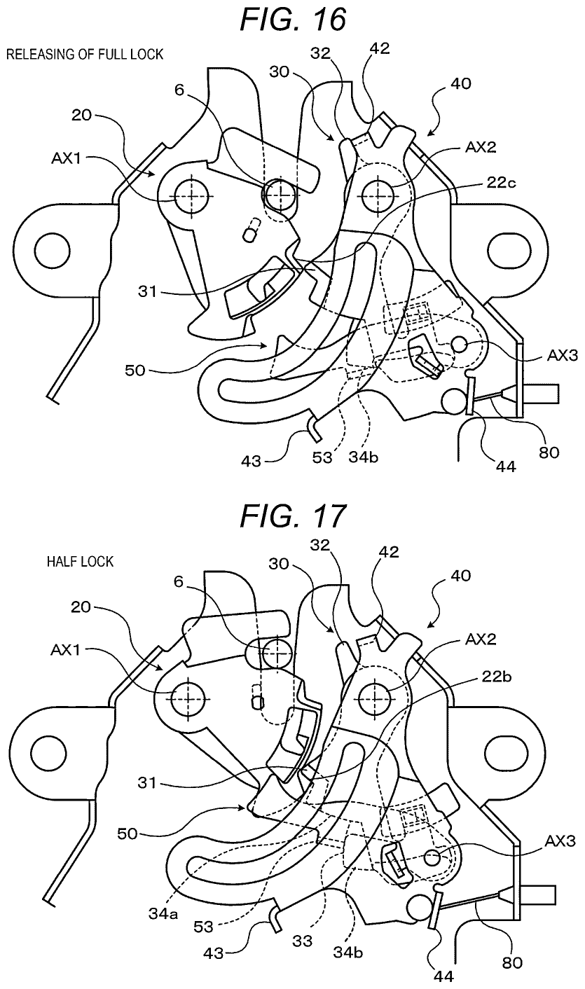

When the unlock lever is operated once by the operator in the fully locked state, the cable 80 is pulled, and the open lever 40 rotates around the axis of the rotation shaft AX2 in the counterclockwise direction (in the other direction) in FIG. 14. When the open lever 40 rotates, the engagement portion 42 of the open lever 40 contacts (engages with) the full release pressed portion 32 (first pressed portion) of the pole 30, as shown in FIG. 15. The pole 30 rotates around the axis of the rotation shaft AX2 in the counterclockwise direction (in the other direction) in FIG. 15 from the full engagement rotation angle (first rotation angle), integrally with the open lever 40 as the open lever 40 rotates. When the open lever 40 rotates to a position before the full stroke, the pole 30 reaches the half engagement rotation angle (second rotation angle), and the engagement portion 31 of the pole 30 is separated from the full engagement surface 22c of the latch 20, as shown in FIG. 16. As a result, the fully locked state is released. Since the latch 20 is biased around the axis of the rotation shaft AX1 in the counterclockwise direction (opening side) in FIG. 16, the latch 20 rotates to the opening side when the fully locked state is released. When the latch 20 rotates to the opening side, the engagement portion 31 of the pole 30 engages with the half engagement surface 22b of the latch 20, as shown in FIG. 17, and the pole 30 locks the latch 20 at the half locked position. As a result, the transition from the fully locked state to the half locked state is made.

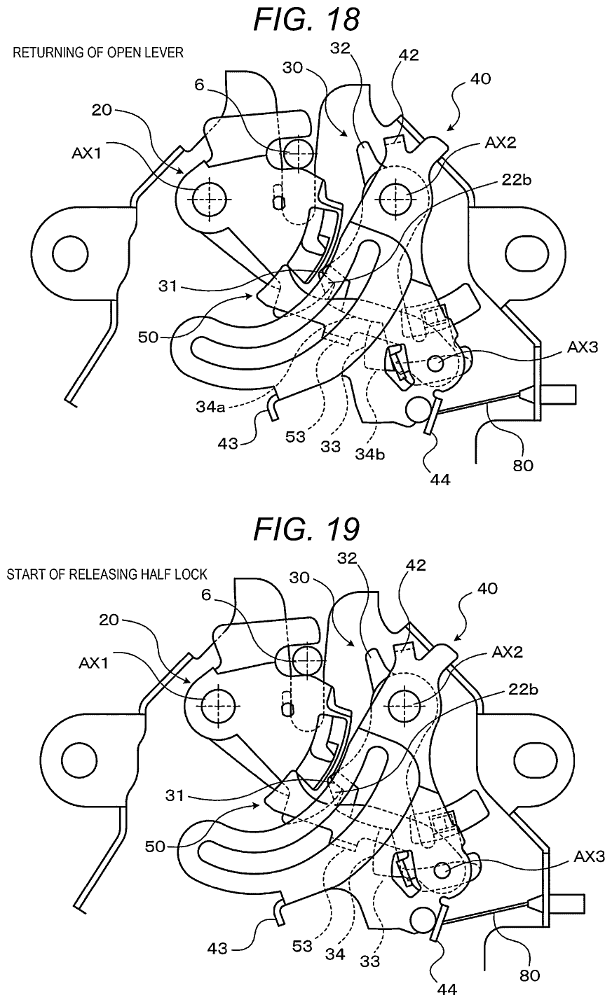

When the operator releases the operation of the unlock lever and the pulling of the cable 80 is released, the open lever 40 rotates around the axis of the rotation shaft AX2 in the clockwise direction (in one direction) in FIG. 18 by the biasing force of the sub-lever spring 54 and returns to the initial position. Since the pole 30 is located around the axis of the rotation shaft AX2 in the counterclockwise direction (in the other direction) in FIG. 18 at the half engagement rotation angle (second rotation angle) than at the full engagement rotation angle (first rotation angle), when the open lever 40 returns to the initial position in the half locked state, the open lever 40 is located at a relatively rotated position around the axis of the rotation shaft AX2 in the clockwise direction (one direction) in FIG. 18 against the pole 30. As a result, the engagement portion 53 of the sub-lever 50 connected to the open lever 40 is detached from the second sub-lever support portion 34b and located near the first sub-lever support portion 34a, and can contact (engage with) the half release pressed portion 33 (second pressed portion). As a result, with the simple configuration of the pole 30, the open lever 40, and the sub-lever 50, the sub-lever 50 can be switched between a state where the sub-lever 50 is not engageable with the half release pressed portion 33 and a state where the sub-lever 50 is engageable with the half release pressed portion 33.

Next, the operation when the half locked state is released will be described with reference to FIGS. 19 to 22.

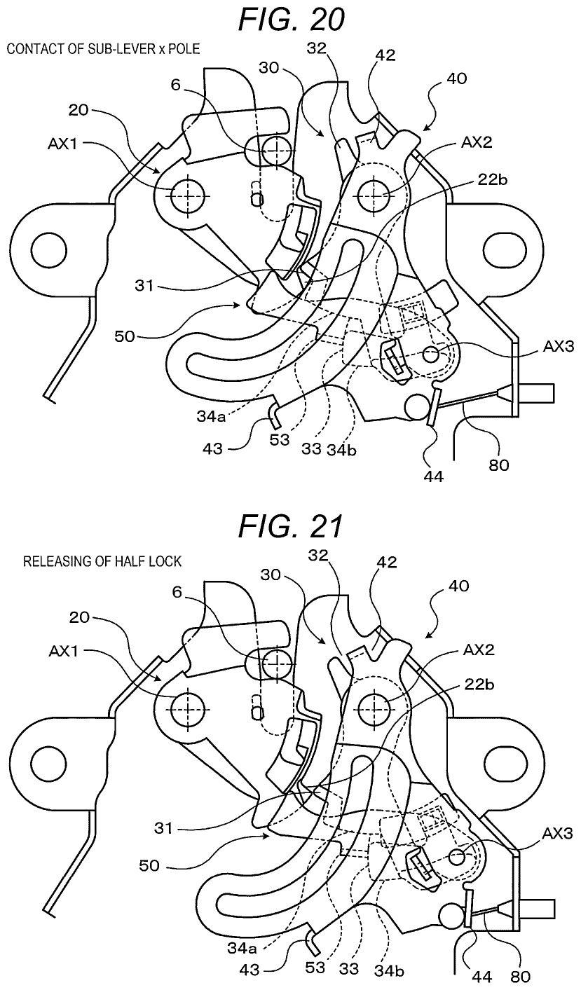

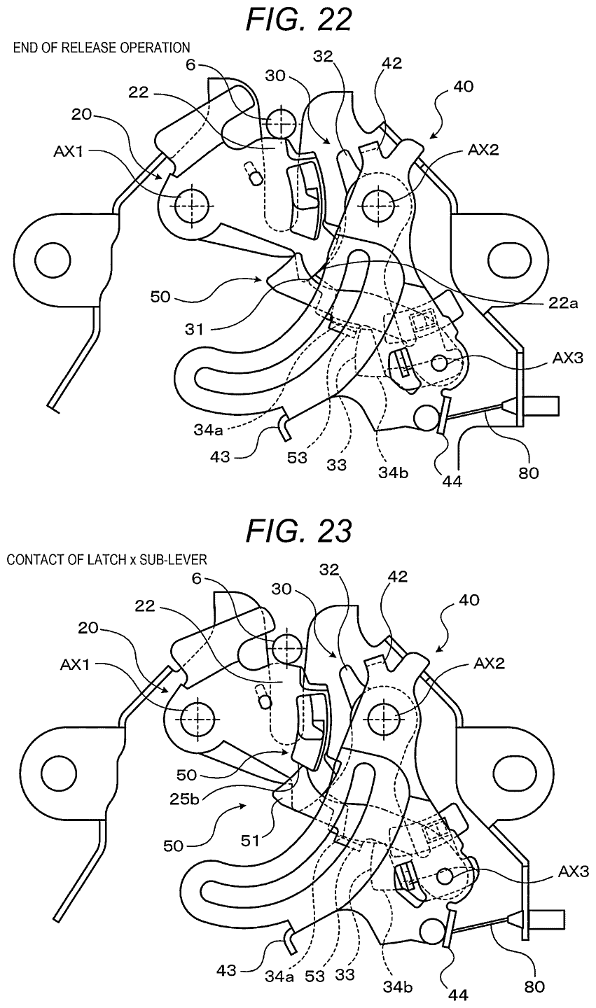

When the unlock lever is operated one more time by the operator in the half locked state, the cable 80 is pulled, and the open lever 40 rotates around the axis of the rotation shaft AX2 in the counterclockwise direction (in the other direction) in FIG. 19. Since the pole 30 is located around the axis of the rotation shaft AX2 in the counterclockwise direction (in the other direction) in FIG. 19 at the half engagement rotation angle than at the full engagement rotation angle, the engagement portion 42 of the open lever 40 does not contact the full release pressed portion 32 (first pressed portion) of the pole 30 even when the open lever 40 rotates in the counterclockwise direction (in the other direction). However, when the open lever 40 rotates in the counterclockwise direction (in the other direction), the engagement portion 53 of the sub-lever 50 connected to the open lever 40 contacts (engages with) the half release pressed portion 33 (second pressed portion) of the pole 30, as shown in FIG. 20. The pole 30 rotates around the axis of the rotation shaft AX2 in the counterclockwise direction (in the other direction) in FIG. 20 from the half engagement rotation angle, integrally with the open lever 40 by pressing the half release pressed portion 33 by the engagement portion 53 of the sub-lever 50 as the open lever 40 rotates. When the open lever 40 rotates to just before the full stroke, the pole 30 reaches the open-engagement rotation angle, and the engagement portion 31 of the pole 30 is separated from the half engagement surface 22b of the latch 20, as shown in FIG. 21. As a result, the half locked state is released. Since the latch 20 is biased around the axis of the rotation shaft AX1 in the counterclockwise direction (opening side) in FIG. 21 by the latch spring 26 and the pop-up spring 64, when the half locked state is released, the latch 20 rotates to the opening side while pushing the striker 6 out with the second claw portion 22, mainly due to the biasing force of the pop-up spring 64. As shown in FIG. 22, when the engagement portion 31 of the pole 30 engages with the open-engagement surface 22a of the latch 20, the latch 20 is in the open state where the latch is rotatable without being restricted by the pole 30. As a result, the striker 6 is released from the latch 20, and the operator can open the hood 4.

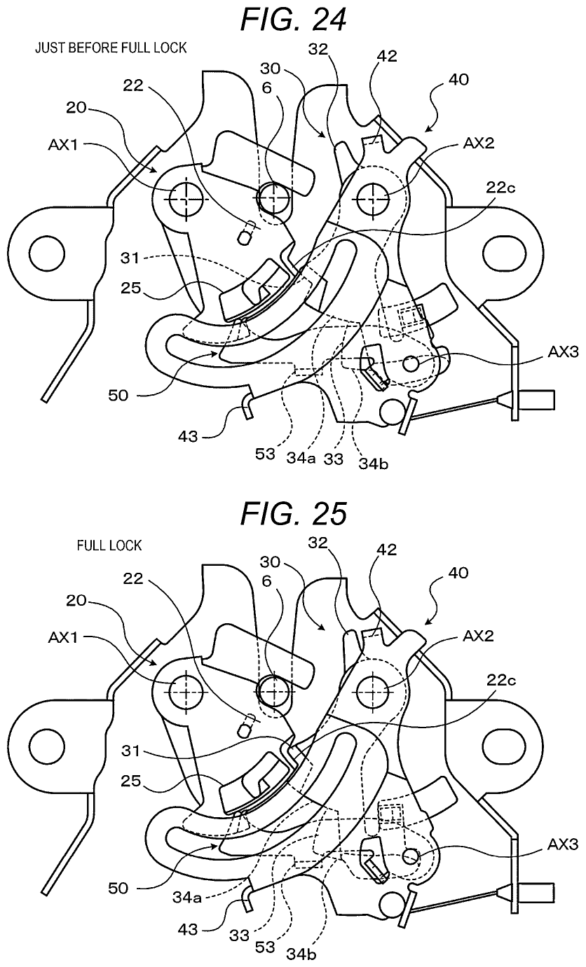

Here, when the hood 4 is opened and fully closed again, the latch 20 rotates around the axis of the rotation shaft AX1 in the clockwise direction (closed side) in FIG. 23 from the open state, as shown in FIG. 23. In this case, the engagement portion 53 of the sub-lever 50 is supported by the first sub-lever support portion 34a of the pole 30, and the free end portion 51 (distal end portion) of the sub-lever 50 contacts the sub-lever contact surface 25c of the engagement block portion 25 formed on the latch 20. The free end portion 51 of the sub-lever 50 is pressed down by the engagement block portion 25 (sub-lever contact surface 25c) as the latch 20 rotates to the closed side toward the fully locked position, as shown in FIG. 24. When the latch 20 rotates to the fully locked position, as shown in FIG. 25, the pole 30 rotates around the axis of the rotation shaft AX2 in the clockwise direction (in one direction) in FIG. 25 to engage with the full engagement surface 22c of the latch 20 at the engagement portion 31. The sub-lever 50 relatively rotates around the axis of the rotation shaft AX2 in the counterclockwise direction (in the other direction) in FIG. 25 against the pole 30 as the pole 30 rotates, and the engagement portion 53 of the sub-lever 50 is located near the second sub-lever support portion 34b of the pole 30. As a result, the sub-lever 50 (engagement portion 53) returns to a state of not being engageable with the half release pressed portion 33 (second pressed portion).

In the above-described embodiment, the hood lock device 10 is fixed to the vehicle body 2, and the striker 6 is fixed to the hood 4, but the hood lock device 10 may be fixed to the hood 4, and the striker 6 may be fixed to the vehicle body 2.

In the above-described embodiment, the vehicle 1 includes a hood opening and closing device that automatically opens and closes the hood 4 electrically, but does not have to include a hood opening and closing device. In this case, the closer drive unit 70 and sector gear 74 may be omitted.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

The present disclosure is applicable to the hood lock device manufacturing industry and other industries.

According to an aspect of this disclosure, a lock device of an opened back door for a vehicle includes a base member fixed to one of an opened back door of a vehicle and a vehicle body, a latch that is rotatable against the base member and engageable with a striker fixed to the other of the opened back door and the vehicle body, and a pole that is rotatable against the base member and engages with the latch to restrict the latch from rotating, in which the device locks the opened back door at a fully closed position by engaging with the striker in the latch, the device further includes an open lever that is rotatable against the base member, and a sub-lever that is rotatable against the open lever, the latch is formed with a half locked engagement portion that engages with the pole in a half locked state and a fully locked engagement portion that engages with the pole in a fully locked state, the half locked engagement portion and the fully locked engagement portion being aligned circumferentially, the pole rotates around an axis of a rotation shaft in one direction as the pole engages with the half locked engagement portion and the fully locked engagement portion in sequence from an open state of the latch, and disengages from the fully locked engagement portion and the half locked engagement portion in sequence as the pole rotates around the axis of the rotation shaft in the other direction opposite to the one direction from the fully locked state, the pole is formed with a first pressed portion with which the open lever is engageable at a first rotation angle which is a rotation angle of the pole when the pole engages with the fully locked engagement portion, and a second pressed portion with which the sub-lever is engageable at a second rotation angle which is a rotation angle of the pole when the pole disengages from the fully locked engagement portion and engages with the half locked engagement portion, and when the open lever rotates in a state where the pole is located at the first rotation angle and engages with the fully locked engagement portion, the open lever engages with the first pressed portion, rotates the pole in the other direction from the first rotation angle to the second rotation angle, and disengages the pole from the fully locked engagement portion, and after the open lever is returned from the rotation thereof, when the open lever rotates in a state where the pole is located at the second rotation angle and engages with the half locked engagement portion, the sub-lever engages with the second pressed portion, rotates the pole in the other direction from the second rotation angle, and disengages the pole from the half locked engagement portion.

In the lock device of an opened back door for a vehicle in the present disclosure, the pole is configured to rotate around the axis of the rotation shaft in one direction as the pole engages with the half locked engagement portion and the fully locked engagement portion in sequence from the open state and to disengage from the fully locked engagement portion and the half locked engagement portion in sequence as the pole rotates around the axis of the rotation shaft in the other direction from the fully locked state. In a state where the pole is located at the first rotation angle (engaged with the fully locked engagement portion), when the open lever rotates to engage with the first pressed portion of the pole, the pole is rotated in the other direction by the open lever. In addition, after the open lever is returned from the rotation thereof, the sub-lever, which is rotatable against the open lever by rotating the open lever in a state where the pole is located at the second rotation angle (engaged with the half locked engagement portion), engages with the second pressed portion of the pole, and the pole is rotated in the other direction together with the sub-lever by the open lever. As a result, the range of rotation of the pole can be set against the rotation of the open lever by the engagement or non-engagement of the sub-lever with respect to the second pressed portion of the pole, and the pole can be prevented from being put into the open state by a single operation from the fully locked state.

What is claimed is:

1. A lock device of an opened back door for a vehicle, the device comprising:
a base member fixed to one of an opened back door of a vehicle and a vehicle body;
a latch that is rotatable against the base member and engageable with a striker fixed to the other of the opened back door and the vehicle body; and
a pole that is rotatable against the base member and engages with the latch to restrict the latch from rotating,
wherein the device locks the opened back door at a fully closed position by engaging with the striker in the latch,
the device further comprises:
an open lever that is rotatable against the base member; and
a sub-lever that is rotatable against the open lever,
the latch is formed with a half locked engagement portion that engages with the pole in a half locked state and a fully locked engagement portion that engages with the pole in a fully locked state, the half locked engagement portion and the fully locked engagement portion being aligned circumferentially,
the pole rotates around an axis of a rotation shaft in one direction as the pole engages with the half locked engagement portion and the fully locked engagement portion in sequence from an open state of the latch, and disengages from the fully locked engagement portion and the half locked engagement portion in sequence as the pole rotates around the axis of the rotation shaft in the other direction opposite to the one direction from the fully locked state,
the pole is formed with a first pressed portion with which the open lever is engageable at a first rotation angle which is a rotation angle of the pole when the pole engages with the fully locked engagement portion, and a second pressed portion with which the sub-lever is engageable at a second rotation angle which is a rotation angle of the pole when the pole disengages from the fully locked engagement portion and engages with the half locked engagement portion, and
when the open lever rotates in a state where the pole is located at the first rotation angle and engages with the fully locked engagement portion, the open lever engages with the first pressed portion, rotates the pole in the other direction from the first rotation angle to the second rotation angle, and disengages the pole from the fully locked engagement portion, and after the open lever is returned from the rotation thereof, when the open lever rotates in a state where the pole is located at the second rotation angle and engages with the half locked engagement portion, the sub-lever engages with the second pressed portion, rotates the pole in the other direction from the second rotation angle, and disengages the pole from the half locked engagement portion.

2. The lock device of an opened back door for a vehicle according to claim 1,
wherein the open lever is rotatable coaxially with the pole against the base member,
as the open lever rotates around the axis of the rotation shaft in the other direction in a state of being at the first rotation angle, the open lever engages with the first pressed portion, and the pole rotates in the other direction, integrally with the open lever from the first rotation angle to the second rotation angle, and
the sub-lever is rotatably connected to the open lever at a position different from the rotation shaft of the open lever, and rotates against the open lever and is engageable with the second pressed portion as the open lever returns to an initial position on the one side around the axis of the rotation shaft in a state where the pole is located at the second rotation angle.

3. The lock device of an opened back door for a vehicle according to claim 1,
wherein when the open lever rotates a predetermined amount from an initial position in a state where the pole is located at the first rotation angle, the pole is rotated in the other direction from the first rotation angle to the second rotation angle, and when the open lever rotates the predetermined amount from the initial position in a state where the pole is located at the second rotation angle, the pole is rotated in the other direction from the second rotation angle.

4. The lock device of an opened back door for a vehicle according to claim 2,
wherein when the open lever rotates a predetermined amount from the initial position in a state where the pole is located at the first rotation angle, the pole is rotated in the other direction from the first rotation angle to the second rotation angle, and when the open lever rotates the predetermined amount from the initial position in a state where the pole is located at the second rotation angle, the pole is rotated in the other direction from the second rotation angle.

5. The lock device of an opened back door for a vehicle according to claim 1,
wherein the pole, the open lever, and the sub-lever are plate-like members that overlap each other in a direction of extension of the rotation shaft, and
at least one of an engagement portion of the open lever that is engageable with the first pressed portion and an engagement portion of the sub-lever that is engageable with the second pressed portion is a bent portion bent on a pole side at an outer edge portion.

6. The lock device of an opened back door for a vehicle according to claim 2,
wherein the pole, the open lever, and the sub-lever are plate-like members that overlap each other in a direction of extension of the rotation shaft, and
at least one of an engagement portion of the open lever that is engageable with the first pressed portion and an engagement portion of the sub-lever that is engageable with the second pressed portion is a bent portion bent on a pole side at an outer edge portion.
